(19) United States
(12) Patent Application Publication
(10) Pub. No.: US 2025/0304260 A1
(43) Pub. Date: Oct. 2, 2025

(54) AIRCRAFT SEAT CONTROL UNIT

(71) Applicant: RECARO Aircraft Seating GmbH & Co. KG, Schwaebisch Hall (DE)

(72) Inventors: Christopher KAUFMANN, Bühlertann (DE); Jörg LAUBENBERGER, Murrhardt (DE); Jürgen MEHMEL, Schwäbisch Hall (DE); Michael STRECKERT, Schwäbisch Hall (DE)

(21) Appl. No.: 18/993,746

(22) PCT Filed: Jul. 12, 2023
(86) PCT No.: PCT/EP2023/069303

§ 371 Date: Jan. 13, 2025

(30) Foreign Application Priority Data
Jul. 14, 2022 (DE) 10 2022 117 644.4

(51) Int. Cl. B64D 11/06; B64D 11/00

(52) U.S. Cl. CPC B64D 11/0639; B64D 11/00155; B64D 11/0624

(57) ABSTRACT

An aircraft seat control unit for an aircraft seat has a function circuit unit, which includes at least one function circuit for controlling the aircraft seat, and has a communication circuit unit which includes at least one communication circuit and is configured for communication with at least one external control unit, wherein the communication circuit unit is realized separately from the function circuit unit, at least with respect to software technology, and the function circuit unit is configured to monitor the communication circuit unit.

### CROSS-REFERENCE TO RELATED APPLICATIONS

This patent application is a U.S. national stage application of international patent application PCT/EP2023/069303, filed on Jul. 12, 2023, which is based on and claims priority to German patent application DE 10 2022 117 644.4, filed on Jul. 14, 2022, the contents of which are incorporated herein by reference.

### PRIOR ART

The invention relates to an aircraft seat control unit.

An aircraft seat control unit for an aircraft seat has previously been proposed, having a function circuit unit which comprises at least one function circuit for controlling the aircraft seat, and having a communication circuit unit which comprises at least one communication circuit and is configured for communication with at least one external control unit.

In particular, the objective of the invention is the provision of a generic device having improved properties with respect to safety. According to the invention, the objective is achieved.

### Advantages of the invention

The invention proceeds from an aircraft seat control unit for an aircraft seat, having a function circuit unit which comprises at least one function circuit for controlling the aircraft seat, and having a communication circuit unit which comprises at least one communication circuit and is configured for communication with at least one external control unit.

It is proposed that the communication circuit unit is realized separately from the function circuit unit, at least with respect to software technology, and that the function circuit unit is configured to monitor the communication circuit unit. An “aircraft seat control unit” is to be understood as a control unit which is configured for controlling an aircraft seat, wherein inputs for controlling the aircraft seat can be executed by a passenger or by a member of staff. “Controlling the aircraft seat” is preferably to be understood as an actuation and operation of electrical and/or electronic components of the aircraft seat such as, for example, actuators, screens or other components which are perceived as appropriate to a person skilled in the art. Controlling the aircraft seat is to be understood, for example, as controlling a lighting function of the aircraft seat, controlling a massage unit of the aircraft seat, controlling the seat heater of the aircraft seat, controlling a door lock for a door which separates a seating area of the aircraft seat from a cabin aisle, controlling a visual protection element, and/or as the processing, control and/or monitoring of further seat components. An “aircraft seat” is to be understood as a seat, in particular an aircraft passenger seat, which is arranged in an aircraft cabin and is preferably mounted on a cabin floor of the aircraft cabin. The aircraft seat provides a seating space for a passenger during a flight. A “function circuit unit” is preferably to be understood as a unit which comprises at least one electronic function circuit, wherein each function circuit of the function circuit unit preferably has a specific functionality, wherein, in principle, it is also possible that a functionality is distributed over a plurality of function circuits. A “function circuit”, in particular, is to be understood as a circuit which is configured for controlling a specific function or a specific functional spectrum of the aircraft seat. The function circuits respectively comprise at least one computer chip. The function circuit unit is configured to execute an operating program which is configured for controlling the aircraft seat. On the function circuit unit or on the function circuits, an operating program is operated for controlling the aircraft seat, which outputs corresponding control signals to the elements of the aircraft seat which are to be controlled. A “communication circuit unit” is to be understood as a circuit unit which comprises at least one communication circuit which is configured to establish a connection to an external control unit, to receive control signals, and to relay them to the function circuit unit. The at least one communication circuit of the communication circuit unit is preferably configured both for wireless communication and for wire-bound communication with an external control unit.

An “external control unit” is to be understood as a unit which is separate from the aircraft seat such as, in particular, a tablet, a smartphone, or another input device which is realized separately from the aircraft seat, wherein the external control unit can also be part of the aircraft cabin or of an aircraft seating area. An external control unit is also preferably to be understood as control or input devices which are part of the aircraft cabin or of the aircraft seating area such as, for example, input devices for cabin crew, or input devices for the in-flight entertainment system (IFE), which also include touchscreens which are arranged in the aircraft seating area. “Separately, with respect to software technology” is to be understood as meaning that, in each case, different operating programs are operated on the separately realized circuit units. On the two circuit units which are realized separately, with respect to software technology, mutually independent operating programs are executed during operation in each case. The circuit units which are realized separately, with respect to software technology, are configured such that, in each case, standalone, mutually independent operating programs are operated thereon. Monitoring the communication circuit by the function circuit is to be understood that the function circuit monitors whether the operating program which runs on the communication circuit is running in an error-free manner. In particular, the function circuit is configured to detect manipulations and/or errors in the operating program which runs on the communication circuit. “Manipulations” are preferably to be understood as unauthorized access attempts by an external device or by malware which runs on the communication circuit. The operating program which is operated on the function circuit unit is preferably realized as a “trustworthy” operating program under the terms of certification specifications (for example EASA CS-25), which represents a secure domain and is comprehensively monitored. The operating program which is operated on the function circuit unit is preferably certified according to DAL D, in accordance with RTCA specification DO 178. The operating program which is operated on the communication circuit unit is preferably realized as an “untrustworthy” operating program under the terms of certification specifications (for example EASA CS-25), which represents a domain which is not mandatorily monitored, wherein the operating program can contain elements which are not subject to licensing. Advantageously, an “untrustworthy” operating program can be cost-effectively updated, as it is not subject to licensing. The operating program which is operated on the communication circuit unit is preferably certified according to DAL E, in accordance with RTCA specification DO 178. In particular, “configured” is to be understood as specifically programmed, furnished and/or equipped. An object being configured for a specific function is in particular to mean that the object fulfils and/or executes this specific function in at least one application and/or operation state. By means of an implementation according to the invention, advantageously, a secure and easy-to-update aircraft seat control unit for communication with external devices can be provided. Preferably, in particular, the communication circuit unit may be realized in such a way that it can be updated in a simple and rapid manner, without the necessity for associated updating of the function circuits of the function circuit unit, as a result of which a complexity of certification can advantageously be reduced. By means of the implementation according to the invention, low certification costs and shorter project durations for the certification of an operating program which is executed on the corresponding circuits can advantageously be achieved.

It is further proposed that the function circuit unit is configured to monitor a communication interface between the function circuit unit and the communication circuit unit. A “communication interface” is preferably to be understood as an interface between the function circuit unit and the communication circuit unit, via which data are exchanged. The communication interface may be realized, for example, as a bus interface, that is to say as a data bus. In principle, it is also conceivable that the communication interface is formed by a serial interface or a binary pin tool. Monitoring the communication interface by the function circuit unit is to be understood as meaning that the function circuit unit monitors the data which are transmitted via the communication interface, in particular from the communication circuit unit to the function circuit unit, and checks them for errors and manipulations. As a result, attempted manipulations of the aircraft seat controller can be detected in a particularly simple manner.

It is further proposed that the function circuit unit, in the event of a detected manipulation of the communication circuit unit or of the communication interface, is configured to at least partially switch off the communication circuit unit and/or to suppress a data exchange between the communication circuit unit and the function circuit unit via the interface. A “detected manipulation” is preferably to be understood as a manipulation which is detected by monitoring the communication circuit unit or the communication interface, for example by any unauthorized access by an unauthorized external device or a malware. “At least partially switch off” is to be understood as meaning that at least one access possibility, in particular a transmission of data from an external device to the communication circuit unit, is suppressed. In principle, it is also conceivable that the communication circuit unit is completely deactivated. Any unauthorized access to, or a manipulation of, the seat controller can advantageously be prevented as a result.

It is moreover proposed that the communication circuit unit is implemented as a circuit board which is realized separately from the function circuit unit and which is directly connected to the function circuit unit via an interface. The interface can be formed, for example, by a bus interface, a serial interface, or another interface which is perceived as appropriate to a person skilled in the art. The communication circuit unit can thus be realized in a particularly simple manner.

It is moreover proposed that the communication circuit unit comprises at least one transmitter and/or receiver module, which is configured for wireless communication and/or for wire-bound communication. A “transmitter and/or receiver module” is preferably to be understood as a module which comprises at least one transmitter and receiver unit for wireless communication such as, for example, an antenna, which is configured for transmitting and receiving a signal according to IEEE standard 802.15.4. The transmitter and/or receiver module is preferably realized as a Bluetooth module, a WLAN module, or as a Zigbee module. The transmitter and/or receiver module preferably comprises a transmitter and receiver unit for wire-bound communication, which comprises at least one interface which is realized as a plug-in connection and via which a corresponding cable for wire-bound communication can be connected. The transmitter and/or receiver module being configured for wire-bound and/or wireless communication is to be understood as meaning that a transmitter and/or receiver module can comprise both a transmitter and receiver unit for wireless communication and a transmitter and receiver unit for wire-bound communication, and also in each case only one of the two transmitter and receiver units. As a result, the communication circuit unit can be realized in a particularly advantageous manner for wireless communication.

It is moreover proposed that the communication circuit unit and the function circuit unit are accommodated in a common housing. A “common housing” is preferably to be understood as a housing which encloses both the function circuit unit and the communication circuit unit, at least essentially, preferably entirely, and which protects against manipulation from the outside. As a result, the aircraft seat control unit can be realized in a particularly compact and manipulation-proof manner.

It is moreover proposed that an operating program which runs on the communication circuit unit is realized as an untrustworthy operating program and is in particular certified according to DAL E. An “untrustworthy operating program” is preferably to mean an operating program which is considered to be untrustworthy under the terms of certification specifications (for example EASA CS-25), on the grounds that it can contain program elements which are not subject to licensing. The untrustworthy operating program represents a domain which is not mandatorily monitored. Certification according to “DAL E” is to be understood as certification for an operating program corresponding to RTCA specification DO 178. As a result, an operating program for the communication circuit unit can be updated in a particularly simple manner and without major complex certification.

A method for operating an aircraft seat control unit having an operating program which runs on a function circuit unit for controlling the aircraft seat, and having an operating program which runs on a communication circuit unit and is configured for external communication is further proposed, wherein the operating program which runs on the function circuit unit has a monitoring function that monitors the communication operating program which runs on the communication circuit unit and/or monitors communication between the function circuit unit and the communication circuit unit. A “monitoring function” is preferably to be understood as a function which is executed by the operating program of the function circuit unit and monitors the communication operating program for irregularities, errors and manipulations. As a result, the communication circuit unit can be monitored in a particularly simple manner, and the aircraft seat control unit can be protected against manipulation from an external source.

It is further proposed that the operating program which runs on the function circuit unit is configured, in the event of a detected error or a detected manipulation, to terminate the communication operating program which runs on the communication circuit unit or to terminate communication between the function circuit unit and the communication circuit unit. As a result, the function circuit unit can be operated in a particularly advantageous manner.

A computer program is further proposed, comprising commands which, upon the execution of the program by a computer, make said computer implement the method/the steps of the method.

The aircraft seat control unit according to the invention is not intended to be limited here to the above-described application and embodiment. In particular, the aircraft seat control unit according to the invention, for executing an operating mode described herein, can comprise a number of individual elements, components and units, which number differs from that specified herein.

### DRAWINGS

Further advantages proceed from the following description of the drawing. An exemplary embodiment of the invention is represented in the drawing. The drawing, the description and the claims contain numerous features in combination. A person skilled in the art, appropriately, will also consider the features individually, and will combine them to form appropriate further combinations.

In the figures:

FIG. 1 shows a schematically represented aircraft seat, having an aircraft seat control unit,

FIG. 2 shows a schematic representation of the aircraft seat control unit according to the invention, having a function circuit unit and a communication circuit unit in a common housing,

FIG. 3 shows a schematic representation of the aircraft seat control unit according to the invention, having a function circuit unit and a communication circuit unit according to a second exemplary embodiment, and

FIG. 4 shows a schematically represented flow diagram of an operating program of the function circuit unit.

### DESCRIPTION OF THE EXEMPLARY EMBODIMENT

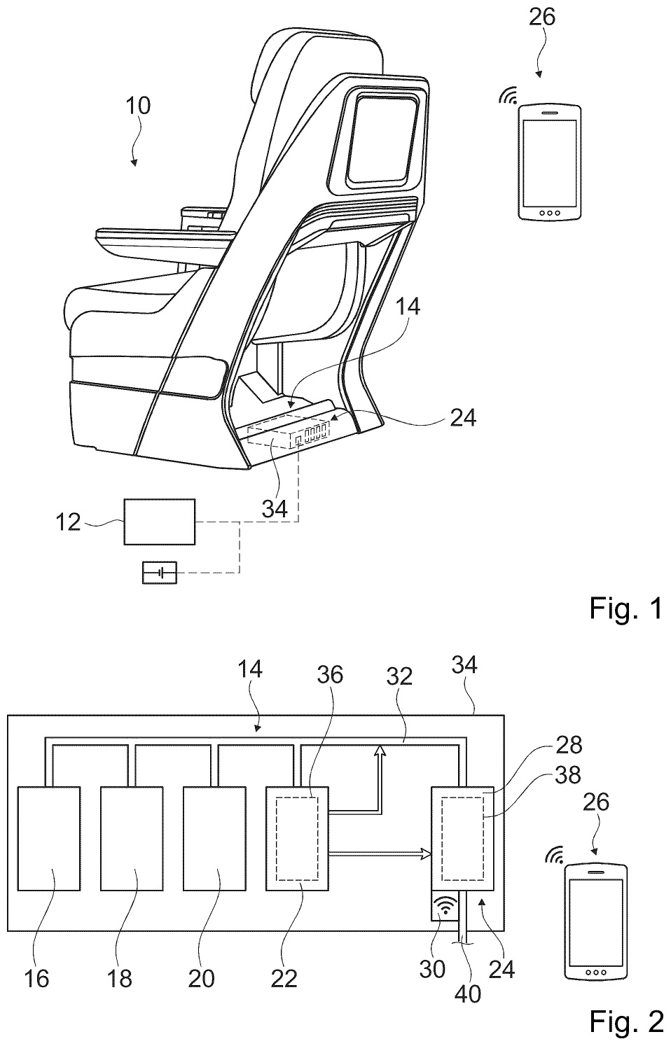

An aircraft seat control unit according to the invention for an aircraft seat 10 is represented in FIGS. 1 to 4. FIG. 1 shows an aircraft seat 10. The aircraft seat 10 illustrated in FIG. 1 is intended to be represented here in a schematic manner only and as an example of an aircraft seat. In principle, it is also conceivable that the aircraft seat 10 has a different implementation, which is perceived as appropriate to a person skilled in the art. The aircraft seat 10 is embodied as a business class or first-class aircraft seat. Naturally, in principle, it is also conceivable that the aircraft seat 10 is embodied as an economy class aircraft seat. The aircraft seat 10 is mounted in an aircraft, which is not represented in greater detail. To this end, the aircraft seat 10 comprises a mounting unit, by means of which the aircraft seat 10 is rigidly connected to a cabin floor of the aircraft. The aircraft comprises aircraft electronics 12. The aircraft electronics 12 comprise a general power supply for electrical and/or electronic components of the aircraft.

The aircraft seat control unit is configured for controlling the aircraft seat 10. For the purposes of control, the aircraft seat control unit comprises a function circuit unit 14. The function circuit unit 14 comprises multiple function circuits 16, 18, 20, 22. In the present implementation, the function circuit unit 14 comprises exactly four function circuits 16, 18, 20, 22. In principle, it is also conceivable that the function circuit unit 14 comprises a different number of function circuits 16, 18, 20, 22. The three first function circuits 16, 18, 20 are only to be considered by way of example for an implementation of the function circuit unit 14 of the aircraft seat control unit. The first function circuit 16 is realized as a seat control circuit. The function circuit 16 which is realized as a seat control circuit is configured to execute control of the aircraft seat 10. The first function circuit 16, which is realized as a seat control circuit, computes control of the aircraft seat 10 on the basis of various input signals. The second function circuit 18 is realized as a light control circuit. The second function circuit 18, which is realized as a light control circuit, is configured for actuating light elements on and around the aircraft seat 10. The third function circuit 20 is implemented as a sensor and/or actuator interface circuit. The third function circuit 20, which is implemented as a sensor and/or actuator interface circuit, is configured for actuating actuators of the aircraft seat 10 and for processing and evaluating sensor signals which are delivered by sensors of the aircraft seat 10. The third function circuit 20, which is implemented as a sensor and/or actuator interface circuit, controls actuators of the aircraft seat 10 on the basis of operator inputs or on the basis of evaluated sensor signals. Moreover, the third function circuit 20, which is implemented as a sensor and/or actuator interface circuit, processes and evaluates sensor signals which are output by sensors of the aircraft seat 10, and outputs corresponding output signals. The first three function circuits 16, 18, 20 are configured for controlling the aircraft seat 10.

The fourth function circuit 22 is realized as a service circuit. The function circuit 22, which is realized as a service circuit, is configured for communication of the function circuits 16, 18, 20 of the function circuit unit 14. Preferably, the function circuit 22, which is realized as a service circuit, is also configured for supplying the function circuit unit 14 with electrical energy. The function circuit 22, which is realized as a service circuit, is configured for monitoring the function circuit unit 14. Preferably, the four function circuits 16, 18, 20, 22 are in each case placed on a dedicated circuit board. The individual circuit boards, on which in each case one of the function circuits 16, 18, 20, 22 is placed, are preferably interconnected by means of an interface circuit. The function circuits 16, 18, 20, 22 are respectively interconnected by means of an internal connection via the interface circuit. The function circuits 16, 18, 20, 22 are preferably interconnected by means of an internal BUS.

The function circuit unit 14, in particular the function circuits 16, 18, 20, 22 are configured to execute an operating program for controlling the aircraft seat 10. An operating program for controlling the aircraft seat 10 is saved on the function circuit unit 14, in particular on the function circuits 16, 18, 20, 22. The operating program for controlling the aircraft seat 10 is executed on the function circuit unit 14 during operation. The operating program for controlling the aircraft seat 10, which is executed on the function circuit unit 14, is realized as control software. The operating program, which is realized as control software, is configured to receive and process input signals and then to output corresponding control signals to the aircraft seat 10. The operating program of the function circuit unit 14 is realized as a “trustworthy” operating program. The operating program of the function circuit unit 14 for controlling the aircraft seat 10 is certified according to DAL D.

The aircraft seat control unit comprises a communication circuit unit 24. The communication circuit unit 24 is configured for communicating with external control units 26. The communication circuit unit 24 is configured for wireless and wire-bound communication with external control units 26. The communication circuit unit 24 is configured for communicating with one of the external control units, such as, in particular, an electronic device, such as a smartphone or tablet, or a control device of an aircraft cabin. In principle, it would also be conceivable for the communication circuit unit 24 to be configured exclusively for wire-bound communication with an external control unit 26. In principle, it would likewise be conceivable for the communication circuit unit 24 to be configured exclusively for wireless communication with an external control unit 26. The communication circuit unit 24 comprises a communication circuit 28. The communication circuit 28 is configured for processing and relaying signals received. The communication circuit unit 24 comprises a transmitter and receiver module 30, which is configured for wireless communication. The transmitter and receiver module 30 is embodied as a wireless transmitter and receiver module. The transmitter and receiver module 30 is configured for wireless communication according to IEEE standard 802.15.4. The transmitter and receiver module 30 is configured for a Bluetooth connection. The transmitter and receiver module 30 comprises a Bluetooth antenna for providing a Bluetooth connection. The transmitter and receiver module is moreover configured for a WLAN connection. The transmitter and receiver module 30 comprises a WLAN antenna for providing a WLAN connection. In principle, it is also conceivable that the transmitter and receiver module 30 is configured for other types of wireless connection and, to this end, comprises a corresponding antenna. The communication circuit unit 24 comprises a second transmitter and receiver module 40, which is configured for wire-bound communication. The second transmitter and receiver module 40 is embodied as a wire-bound transmitter and receiver module. The wire-bound transmitter and receiver module 40 comprises a plug-in unit. The plug-in unit of the wire-bound transmitter and receiver module 40 is realized as an interface, via which a cable is connectable to the communication circuit unit 24. Via the interface of the wire-bound transmitter and receiver module 40, aircraft electronics or another external control unit can be connected to the communication circuit unit 24 by means of a cable. The communication circuit unit 24 is realized separately from the function circuit unit 14, with respect to software technology. The communication circuit unit 24 is configured to execute an operating program for communicating with external control units 26. The operating program for wireless or wire-bound communication is saved on the communication circuit unit 24, in particular on the communication circuit 28. The operating program for communication is executed on the communication circuit unit 24 during operation. The operating program for communication, which is executed on the communication circuit unit 24, is realized as communication software. The operating program which is operated on the communication circuit unit 24 and is realized as communication software is realized separately from the operating program which is operated on the function circuit unit 14 and is realized as control software. The operating program of the communication circuit unit 24, which is realized as communication software, is realized as a standalone operating program. The operating program of the communication circuit unit 24, which is realized as communication software, is realized as an “untrustworthy” operating program. The operating program which is realized as communication software and is classified as untrustworthy can comprise uncertified program elements. In the case of a modification, it is not necessary for the uncertified program elements to be recertified by corresponding certification authorities of an airline or an aircraft manufacturer, when modifications are made to the program elements. The operating program of the communication circuit unit 24 for communicating with external control units is certified according to DAL E.

The function circuit unit 14 is configured to monitor the communication circuit unit 24. The operating program which is operated on the function circuit unit 14 and is realized as control software is configured to monitor the operating program which is operated on the communication circuit unit 24 and is realized as communication software. The operating program of the function circuit unit 14, which is realized as control software, monitors whether the operating program of the communication circuit unit 24, which is realized as communication software, runs normally in the stipulated parameters. The operating program of the function circuit unit 14, which is realized as control software, is configured to detect errors, unauthorized access operations and manipulations of the operating program which is operated on the communication circuit unit 24.

The aircraft seat control unit comprises a communication interface 32. The communication interface 32 is arranged between the function circuit unit 14 and the communication circuit unit 24. The communication interface 32 forms a data exchange interface between the function circuit unit 14 and the communication circuit unit 24. The communication interface 32 is realized as a BUS interface. In principle, it would also be conceivable that the communication interface 32 is realized as a different interface for the purposes of data exchange. The function circuit unit 14 and the communication circuit unit 24 exchange corresponding data via the communication interface 32. The function circuit unit 14 is configured to monitor a communication interface 32 between the function circuit unit 14 and the communication circuit unit 24. The operating program which runs on the function circuit unit 14 monitors the data which are transmitted from the communication circuit unit 24 to the function circuit unit 14. The function circuit unit 14 is configured to check the data which are transmitted from the communication circuit unit 24 to the function circuit unit 14 for manipulations, errors and malware. The function circuit unit 14 is configured to check the data which are transmitted from the communication circuit unit 24 to the function circuit unit 14. The operating program which runs on the function circuit unit 14 is configured to detect manipulations, errors and malware in the data to be transmitted via the communication interface 32 from the communication circuit unit 24 to the function circuit unit 14.

In the event of a detected manipulation of the communication circuit unit 24 or of the communication interface 32, the function circuit unit 14 is configured to at least partially switch off the communication circuit unit 24. The operating program which runs on the function circuit unit 14 at least partially switches off the communication circuit unit 24 in the event of a detected manipulation or in the event of detected malware. Preferably, at least the transmitter and receiver module 30, in the event of a detected manipulation or detected malware, is switched off, such that no further data can be transmitted from an external control unit to the communication circuit unit 24 and then the function circuit unit 14. In principle, it is also conceivable that only part of the corresponding antennae of the transmitter and receiver module 30 is switched off, via which a detected manipulation or a detected attempt at manipulation has occurred.

Alternatively or additionally, the function circuit unit 14, in the event of a detected manipulation of the communication circuit unit 24 or of the communication interface 32, is configured to suppress an exchange of data between the communication circuit unit 34 and the function circuit unit 14 via the communication interface 32. The operating program which runs on the function circuit unit 14 prevents any transmission of data via the communication interface 32 in the event of a detected manipulation or in the event of detected malware. After a detected manipulation or in the event of detected malware, the operating program of the function circuit unit 14 suppresses any transmission of data from the communication circuit unit 34 to the function circuit unit 14, as a result of which any external access to the function circuit unit 14 is prevented.

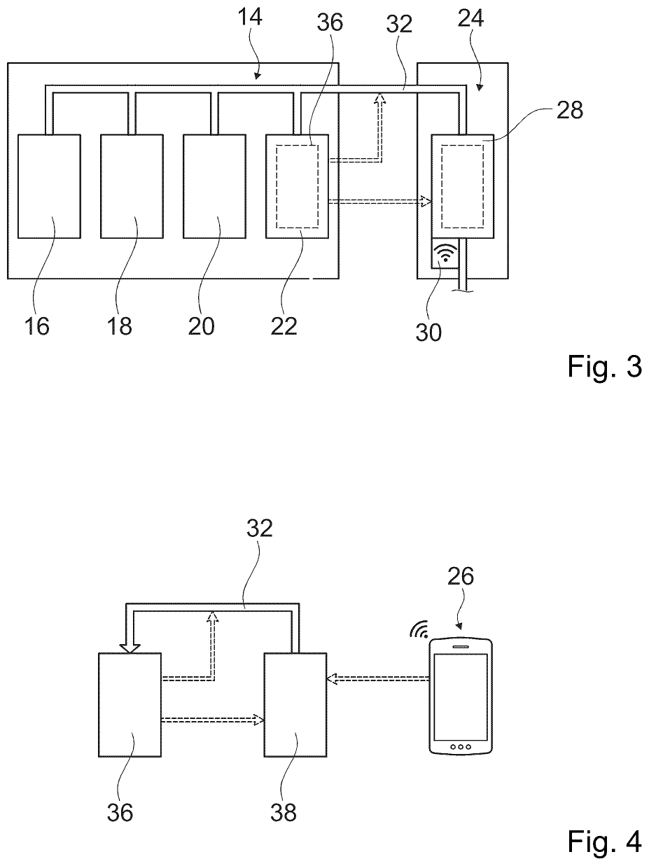

In a first implementation, as shown in FIG. 2, the communication circuit unit 24 is realized as a circuit board, which is realized separately from the function circuit unit 14. The communication circuit unit 24 is directly connected to the function circuit unit 14 via a communication interface 32, which is realized as an internal BUS. The communication circuit unit 24 and the function circuit unit 14 are accommodated in a common housing 34. In principle, in a further implementation according to FIG. 3, it would also be conceivable for the communication circuit unit 24 to be implemented as a unit which is spatially separate from the function circuit unit 14. The communication circuit unit 24 might be arranged in a dedicated housing at a different location from the function circuit unit 14.

A method according to the invention for operating an aircraft seat control unit having an operating program 36, which runs on a function circuit unit 14, for controlling the aircraft seat 10, and having an operating program 38, which runs on a communication circuit unit 24 and is configured for external communication, is to be described briefly hereinafter.

The operating program 36 which runs on the function circuit unit 14 comprises a monitoring function. The monitoring function of the operating program 36 monitors the operating program 38 which runs on the communication circuit unit 24. The monitoring function of the operating program 36 monitors whether the operating program 38 of the communication circuit unit 24 is running in its normal parameters. The operating program 36 of the function circuit unit 14 detects if the operating program 38 of the communication circuit unit 24 is not running in its normal parameters, and detects attempted manipulations by an external control unit, or a malfunction of the external control unit results in an error.

The monitoring function of the operating program 36 monitors communication between the function circuit unit 14 and the communication circuit unit 24. The monitoring function of the operating program 36 monitors the data which are transmitted via the communication interface 32 from the communication circuit unit 24 to the function circuit unit 14. The monitoring function of the operating program 36 detects manipulations of the data transmitted, in particular malware, manipulated data, or a malfunction.

The operating program 36 which runs on the function circuit unit 14 is configured, in the event of a detected error or a detected manipulation, to terminate the operating program 38 which runs on the communication circuit unit 24, or to terminate communication between the function circuit unit 14 and the communication circuit unit 24. In the event that the monitoring function of the operating program 36 detects, for example, a manipulation or malware, the operating program 36 of the function circuit unit 14 terminates the operating program 38 of the communication circuit unit 24 or switches it to a secure mode, in which access by an external control unit 26 is no longer permitted. In principle, it is conceivable that the operating program 36 of the function circuit unit 14 suppresses transmission of data via the communication interface 32, wherein external access to the communication circuit unit 24 remains. Data logging, i.e. saving data relating to a disturbance of the operating program of the communication circuit unit 24 is executed by the operating program of the function circuit unit. Thus, in particular, data with respect to an error or a manipulation, for example a time, or where the error or the manipulation occurred in the program code, can be saved in a traceable and secure manner, and are retrievable for analysis.

As a result of the separation of the function circuit unit 14 and the communication circuit unit 24, with respect to software technology, and the monitoring of the operating program 38 of the communication circuit unit 24 by the operating program 36 of the function circuit unit 14, the operating program 38 of the communication circuit unit 24 can be “untrustworthy”, for example certified according to DAL E only, whereas the operating program 36 of the function circuit unit 14 is “trustworthy”, and is certified, for example, according to DAL D. As a result, the operating program 38 of the communication circuit unit 24 can be modified and updated in a particularly simple manner, and without high certification costs, in the event that security vulnerabilities are identified in the operating program 38 of the communication circuit unit 24. Advantageously, by means of the separation, an additional certification of the operating program 36 of the function circuit unit 14, in conjunction with an update of the operating program 38 of the communication circuit unit 24, can be prevented.

1. An aircraft seat control unit for an aircraft seat, having a function circuit unit, which comprises at least one function circuit for controlling the aircraft seat, and having a communication circuit unit which comprises at least one communication circuit and is configured for communication with at least one external control unit, wherein the communication circuit unit is realized separately from the function circuit unit, at least with respect to software technology, and the function circuit unit is configured to monitor the communication circuit unit.

2. The aircraft seat control unit as claimed in claim 1, wherein the function circuit unit is configured to monitor a communication interface between the function circuit unit and the communication circuit unit.

3. The aircraft seat control unit as claimed in claim 1, wherein the function circuit unit, in the event of a detected manipulation of the communication circuit unit or of the communication interface, is configured to at least partially switch off the communication circuit unit and/or to suppress a data exchange between the communication circuit unit and the function circuit unit via the communication interface.

4. The aircraft seat control unit as claimed in claim 1, wherein the communication circuit unit is implemented as a board which is realized separately from the function circuit unit and is directly connected to the function circuit unit via a bus.

5. The aircraft seat control unit as claimed in claim 1, wherein the communication circuit unit comprises at least one transmitter and/or receiver module, which is configured for wireless communication and/or for wire-bound communication.

6. The aircraft seat control unit as claimed in claim 1, wherein the communication circuit unit and the function circuit unit are accommodated in a common housing.

7. The aircraft seat control unit as claimed in claim 1, wherein an operating program which runs on the communication circuit unit is realized as an untrustworthy operating program and is in particular certified according to DAL E.

8. A method for operating an aircraft seat control unit having an operating program, which runs on a function circuit unit, for controlling the aircraft seat, and having an operating program which runs on a communication circuit unit and is configured for external communication, wherein the operating program which runs on the function circuit unit has a monitoring function which monitors the operating program, which runs on the communication circuit unit, and/or monitors communication between the function circuit unit and the communication circuit unit.

9. The method for operating an aircraft seat control unit as claimed in claim 8, wherein the operating program which runs on the function circuit unit is configured, in the event of a detected error or a detected manipulation, to terminate the operating program which runs on the communication circuit unit or to terminate communication between the function circuit unit and the communication circuit unit.

10. A computer program comprising commands which, upon the execution of the program by a computer, make said computer execute the method as claimed in claim 8.

11. A computer program comprising commands which, upon the execution of the program by a computer, make said computer execute the method as claimed in claim 9.
